(19) United States
(12) Patent Application Publication
(10) Pub. No.: US 2024/0188753 A1
(43) Pub. Date: Jun. 13, 2024

(54) SMART BEVERAGE DISPENSERS AND ASSOCIATED SYSTEMS AND METHODS

(71) Applicant: Voga Coffee, Inc., Wyomissing, PA (US)

(72) Inventors: Eli Salomon, San Francisco, CA (US); Joshua Lewis Avins, San Francisco, CA (US)

(21) Appl. No.: 18/537,650

(22) Filed: Dec. 12, 2023

Related U.S. Application Data
(60) Provisional application No. 63/432,328, filed on Dec. 13, 2022.

(51) Int. Cl. A47J 31/52

(52) U.S. Cl. CPC A47J 31/525; A47J 31/521

(57) ABSTRACT

A beverage dispenser and/or dispenser system including an airpot, a tilt sensor, and a controller are disclosed herein. In a representative example, the airpot includes a vessel used to contain coffee or another brewed/steeped beverage. The airpot can further include a liquid level sensor positioned to detect a liquid level within the vessel. The tilt sensor and the controller can be carried by the airpot. The controller is operably coupled with the liquid level sensor and the tilt sensor and has a computer-readable medium carrying instructions that, when executed, cause the controller to (i) receive, from the liquid level sensor, a first signal corresponding to a first liquid level, (ii) determine, in response to a signal from the tilt sensor, the occurrence of an inversion event, (iii) receive, from the liquid level sensor, a second signal corresponding to a second liquid level, and (iv) determine a liquid level change based on the first and the second signals. The change can be used to monitor dump events and reduce beverage waste.

### CROSS-REFERENCE TO RELATED APPLICATION

The present application claims priority to pending U.S. Provisional Application No. 63/432,328, filed on Dec. 13, 2022 and incorporated herein by reference in its entirety.

### TECHNICAL FIELD

The present technology is directed generally to smart beverage dispensers and associated systems and methods.

### BACKGROUND

Coffee has been a commonly-consumed beverage for many years. Over the course of time, many techniques have been developed to brew coffee, with each having its own advantages and disadvantages. For example, siphon coffee brewers were developed in the 1830s and were known to produce flavorful coffee, with little bitterness. Percolators were initially developed in the 1800s, and became popular in the first half of the twentieth century. Percolators have largely been replaced with drip coffee makers, which are simple and produce acceptable coffee. For larger groups or in commercial settings, coffee can be made using a large-scale brewer that directs coffee into multiple pots or a single, large-scale dispenser. One example of a large-scale dispenser is an airpot.

One drawback associated with the foregoing types of coffee makers is that all are relatively simple in function. Each heats water that is mixed with coffee grounds to produce coffee for serving and consumption. The quantity and quality of the coffee can only be identified through observation and/or consumption by the individual brewing or drinking the coffee. Further, quantity and quality of the coffee can only be tracked over time, across multiple brewing cycles through first-hand, subjective experience recorded in handwritten or text-entered notes. Inconsistencies in notetaking and/or burdens associated with reviewing notes can lead to inconsistent coffee quality, producing inconsistent customer experiences, and can lead to inaccurate coffee volume production, requiring unconsumed coffee to be discarded.

### BRIEF DESCRIPTION OF THE DRAWINGS

FIG. 1 is a partially schematic perspective view of a smart brewer system configured in accordance with embodiments of the present technology.

FIGS. 2A and 2B are partially schematic side and lower rear views, respectively, of a smart dispenser configured in accordance with embodiments of the present technology.

FIG. 3 is a diagram illustrating a smart brewer network configured in accordance with embodiments of the present technology.

FIG. 4 is a flow diagram illustrating a representative process for tracking amounts of disposed coffee, in accordance with embodiments of the present technology.

### DETAILED DESCRIPTION

### 1.0 Overview

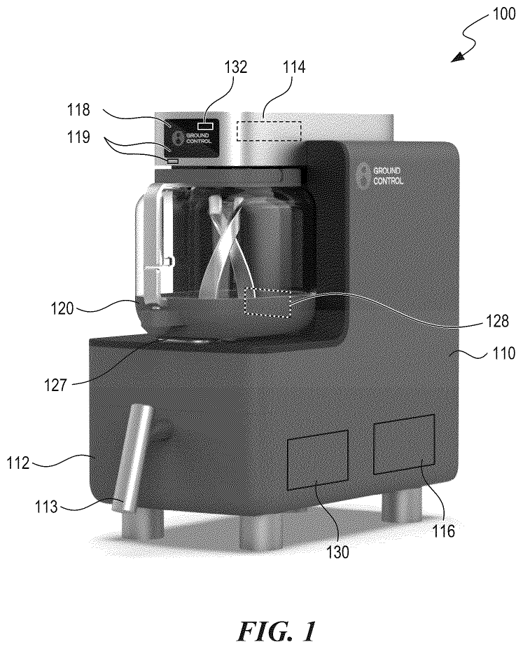

The present technology is directed generally to smart brewing systems including one or more of a smart brewer and a smart beverage dispenser, and associated systems and methods. Such smart brewing systems can be suitable for residential and/or commercial purposes depending on the particular embodiment. Specific details of several embodiments of the present technology are described below with reference to particular, representative configurations. In other embodiments, the present technology can be practiced in accordance with brew systems or coffee makers having other configurations. Specific details describing structures or processes that are well-known and often associated with brew systems, but that can unnecessarily obscure some significant aspects of the presently disclosed technology, are not set forth in the following description for purposes of clarity. Moreover, although the following disclosure sets forth several embodiments of different aspects of the disclosed technology, several other embodiments of the technology can have configurations and/or components different than those described in this section. In particular, several embodiments of the present technology are described in the context of an airpot, but the technology applies as well to any suitable beverage dispenser, server, vessel, an/or other container, and, unless expressly stated, is not limited to an airpot. As such, the present technology can have other embodiments with additional elements and/or without several of the elements described below with reference to FIGS. 1-4.

Aspects of the present technology are generally directed to: (i) smart brewer systems, (ii) smart brewer networks, and (iii) methods for tracking beverage disposal. Each of the foregoing elements can include several embodiments, which can be combined with embodiments of the remaining elements in any of a variety of suitable manners. For example, the smart brewer system can be implemented in or combined with the smart brewer networks. Further, the methods for tracking beverage disposal can be implemented in or combine with either the smart brewer system or the smart brewer network.

In particular, embodiments of the smart brewer system can include one or more smart brewers and one or more smart airpots interconnected using a wired or wireless connection to facilitate smart brewer system operation, track information regarding brew cycles, and improve system performance. For example, instructions can be provided by a user at the brewer and/or at the airpot to control a brewing process of the brewer. The brewer and/or the airpot can then track information regarding the brewing process and a beverage produced thereby. Subsequently, the airpot can identify events during which portions of the beverage are disposed of (e.g., dump events) using methods disclosed herein. Information regarding these dump events can be tracked by the airpot and/or the brewer and reviewed by the user to improve future smart brewer system use.

Embodiments of the smart brewer network can incorporate components and/or assemblies similar to those of the smart brewer system, into a brewer network. Smart brewer systems incorporated into the brewer network can provide information regarding brew cycles and system performance to the network for review by a user. The information can further include dump event information including, for example, distinguishing when a smart airpot is inverted and a beverage disposed therefrom versus when a liquid is poured from the smart airpot but not disposed of, as identified using methods disclosed herein. The user can then review information regarding the network's smart brewer systems on a large-scale to improve network performance overall. For example, the user can seek to identify trends in dump events to at least reduce or eliminate such events and thereby lower system operating costs.

The foregoing processes can be controlled to accurately produce and repeat the timing sequences associated with the processes. The processes can be controlled mechanically, for example, with a mechanical clock mechanism that mechanically or electromechanically operates valves, servos, and/or other actuatable elements. In another embodiment, a digital controller (e.g., a computer or computer-based system) directs the processes used to conduct the brewing methods. For example, the computer or controller can include computer-based (e.g., programmable) instructions that are coupled to electromechanical valves, servos, and/or other actuators.

As noted above, several embodiments of the disclosed technology can take the form of computer-executable instructions, including routines executed by a programmable computer or controller. Those skilled in the relevant art will appreciate that the technology can be practiced on computer or controller systems other than those shown and described below. The technology can be embodied in a special-purpose computer, controller, or data processor that is specifically programmed, configured, or constructed to perform one or more of the computer-executable instructions described below. Accordingly, the terms “computer” and “controller” as generally used herein refer to a suitable data processor and can include hand-held devices, wearable devices, cellular or mobile phones, multi-processor systems, processor-based or programmable consumer electronics, network computers, mini computers, and the like. Information handled by these computers can be presented at any suitable display media, including a liquid crystal display (LCD) or organic light-emitting diode (OLED). Further, these display media can include touchscreen interfaces for receiving inputs from a user in response to information presented thereon. In other embodiments, buttons, switches, and/or other similar physical interfaces can be positioned near or adjacent to the display media to receive user inputs.

The present technology can also be practiced in distributed environments, where tasks or modules are performed by remote processing devices that are linked through a communications network. In a distributed computing environment, program modules or subroutines can be located in local and remote memory storage devices. Aspects of the technology described below can be stored or distributed on computer-readable media, including magnetic or optically readable or removable computer discs, as well as distributed electronically over networks. Data structures and transmissions of data particular to aspects of the technology are also encompassed within the scope of the present technology.

### 2.0 Selected Embodiments of the Smart Brewer Systems

FIG. 1 is a partially schematic, perspective view of a smart brewer system 100, configured in accordance with embodiments of the present technology to identify, track, and share characteristics of a brewed beverage. The brewer system 100 can include a smart brewer 110 and a smart airpot 120, with the brewer 110 configured to brew the beverage, such as coffee, which is then transferred into the airpot 120. As illustrated in FIG. 1, the brewer 110 can include: (i) a brew chamber 112 for brewing the beverage and (ii) a brewer connection port 128 (positioned behind the airpot 120) for (a) transferring the beverage from the brew chamber 112 to the airpot 120, (b) providing electricity to the airpot 120, and/or (c) facilitating communication between one or more airpots 120 and the brewer 110. The brewer 110 can further include (iii) a water heater 116 for providing heated water to the brew chamber 112, (iv) a brewer display 118 for showing and/or receiving information regarding the brewing process, (v) input devices 119 (which can be incorporated into the brewer display 118 (e.g., via a touchscreen) or positioned adjacent to the brewer display 118 (e.g., via buttons)), and (vi) a brewer controller 130 for managing the brewer system 100 and the brewing process.

In some embodiments, the brewer system 100 can include a dispenser 114 for transferring (e.g., dispensing) the beverage into the airpot 120 in addition to, or as an alternative to, the brewer connection port 128. For purposes of illustration, the dispenser 114 is shown schematically in FIG. 1. In most instances, it is expected that the system 100 would include either the connection port 128 or the dispenser 114, but in some embodiments, the system 100 may include both. In some embodiments, the brewer system 100 can include one or more additional controllers incorporated into other elements of the brewer 110 to assist in managing the brewer system 100 and the brewing process. For example, the brewer 110 can include an operations controller (e.g., the brewer controller 130) for managing operation of the brewer 110 (e.g., brewing the beverage), and can include a display controller 132 coupled to the display 118 for managing communications with the airpot 120, receiving brewing instructions from a user via the input devices 119, sending brewing instructions to the operations controller, and/or other similar operations performed by the operations controller. In some embodiments, the brewer system 100 can include one or more additional airpots 120. In these embodiments, the brewer 110 can include one or more additional brewer connection ports 128 and/or dispensers 114 corresponding to at least one of the additional airpots 120.

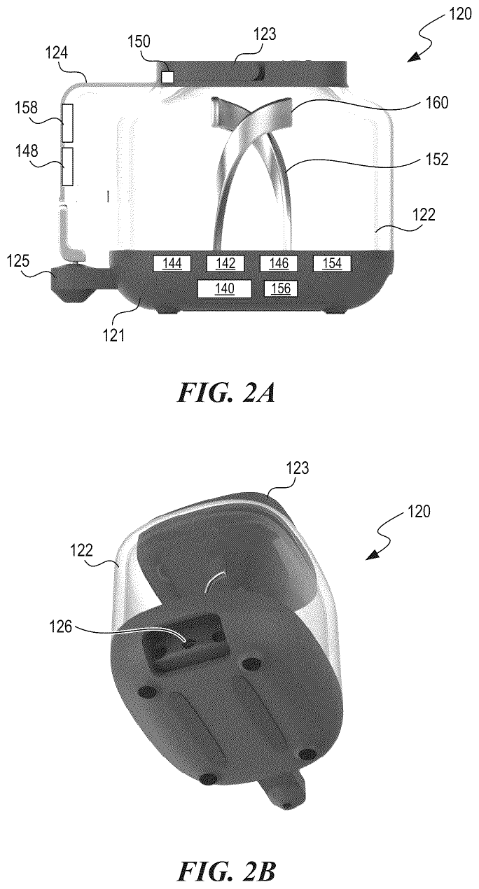

The brewer 110 can be configured to receive and carry the airpot 120 at least when the brewer 110 transfers the beverage into the one or more airpots 120. For example, the airpot 120 can rest on a surface of the brewer 110 with the brewer connection port 128 aligned with an airpot connection port 126 (FIG. 2B). The brewer connection port 128 can selectably be in fluid communication with the airpot connection port 126 for transferring the beverage from the brewer 110 (e.g., from the brew chamber 112) to the airpot 120. Additionally or alternatively, the brewer 110 can dispense the beverage into the airpot 120 using the dispenser 114. Further, in some embodiments, the brewer 110 can dispense the beverage into the airpot 120 while the airpot 120 is positioned laterally adjacent to the brewer 110 and carried by a surface other than one provided by the brewer 110. In some embodiments, the brewer 110 can be configured to transfer the beverage into more than one airpot 120 via one or more brewer connection ports 128 and/or dispensers 114. When configured to receive and carry one or more airpots 120, the brewer 110 can further include one or more heating elements 127. The heating elements 127 can be configured to keep a beverage in the airpots 120 warm when carried by the brewer 110.

The brew chamber 112 can be integrally formed with or removeable from the brewer 110, and further can be an individual component or subassembly of the brewer 110. The brew chamber 112 can include a handle 113 for selectively accessing a portion of the brew chamber 112 configured to receive a brewing compound and heated water from the water heater 116 to prepare a brewed beverage. The brewing compound can include coffee grounds, tea leaves, or any other suitable brewing compound. The brew chamber 112 can include a slidable drawer, operated by the user with the handle 113, having a basket, funnel, and/or other suitable structure therein for receiving the brewing compound and the heated water. The brew chamber 112 can further include a reusable or non-reusable filter or screen positioned within at least a portion of the brew chamber 112 to prevent unwanted portions of the brewing compound from remaining in the beverage. Once the beverage is prepared, the beverage can be routed through a structure (e.g., one or more pipes, conduits, channels, or similar structures not visible in FIG. 1) within the brewer 110 to the brewer connection port 128 and/or the dispenser 114 for transfer to the airpot 120. In some embodiments, the filter or screen can additionally or alternatively be included in the routing structure of the brewer 110.

When the brewer 110 is intended for use with coffee grounds as the brewing compound, the grounds can be placed in a filter within the brew chamber 112 and the brewer 110 can be configured to drip or pour heated water over the grounds. The dripped or poured water can pass through the grounds, producing coffee. The coffee can collect within a portion of the brew chamber 112 and/or other portions of the brewer 110 for routing to the brewer connection port 128 and/or the dispenser 114. Additionally or alternatively, the coffee can be directly routed to the brewer connection port 128 and/or the dispenser 114 and into the airpot 120, bypassing any collection step. As a further example, when the brewer 110 is intended for use with loose or bagged tea leaves or a similar steeped brewing compound, the brewing compound can be placed within the brew chamber 112 and the brewer 110 can be configured to combine heated water with the brewing compound to steep. The steeped beverage can then be removed from the brewing compound, or the brewing compound removed from the brewed beverage, and the beverage routed to the brewer connection port 128 and/or the dispenser 114.

The brewer connection port 128 can be any suitable structure configured to couple (e.g., releasably couple) with the airpot connection port 126 (FIG. 2B), and transfer the beverage from the brewer 110 to the airpot 120 via the brewer connection port 128 and the airpot connection port 126. For example, the brewer connection port 128 can include one or more fluid fittings (e.g., male and/or female tubes, fittings, and/or similar receivers) coupled to, or integrally formed with, the brewer 110 and/or a structure thereof. The one or more fluid fittings can receive the beverage from the brew chamber 112 (e.g., through one or more pipes, conduits, channels, and/or similar structures not visible in FIG. 1), and transfer the beverage to the airpot 120 through one or more corresponding fittings of the airpot 120. In some embodiments, the brewer connection port 128, or a portion of the structure between the brewer connection port 128 and the brew chamber 112, can include a stop (e.g., a one-way valve) to prevent reverse beverage flow from the brewer connection port 128 to the brew chamber 112 and/or to close (e.g., seal, and/or obstruct) the brewer connection port 128 when not coupled with the airpot connection port 126.

When the brewer 110 includes the dispenser 114, the dispenser 114 can be any suitable structure configured to dispense the brewed beverage into the airpot 120 thereunder. For example, the dispenser 114 can have a spout, faucet, nozzle, spigot, tubing, and/or other suitable configuration with an opening in fluid communication with the routing structure and the brew chamber 112. The dispenser 114 can extend over the portion of the brewer 110 configured to receive and carry the airpot 120, or the dispenser 114 can extend over a surface laterally adjacent to the brewer 110. In embodiments for which the brewer 110 includes more than one dispenser 114, all the dispensers 114 can extend over a portion of the brewer 110 and/or over a surface laterally adjacent to the brewer 110, or at least one dispenser 114 can extend over a portion of the brewer 110 and at least one dispenser 114 can extend over a surface laterally adjacent to the brewer 110.

The water heater 116 can be any suitable water heater sized to be carried by the brewer 110, and configured to heat water for brewing the beverage in the brew chamber 112. For example, water heater 116 can be an on-demand electric water heater configured to heat a set volume or volume flowrate of water to a specified temperature (e.g., between 135° F. and 212° F. (57° C. and 100° C.)), which is then delivered to the brew chamber 112. The water heater 116 can be in fluid communication with and receive water from a reservoir within the brewer 110 or an external water source. Additionally or alternatively, the brewer 110 can include a fluid connection with a heated water source external to the brewer 110. When the brewer 110 is connected to an external heated water source, heated water from the external source can bypass the water heater 116 and be directly provided to the brew chamber 112.

The brewer controller 130 can be configured to facilitate operation (e.g., a brewing cycle) of the brewer 110 and monitor and store information regarding the brewer 110 and the prepared beverages. Additionally, the brewer controller 130 can be configured to receive information from and/or provide information to the brewer display 118, a network external to the brewer system 100, and/or the airpot 120 by a direct connection (e.g., wired, optical, or similar physical connection) and/or a wireless connection (e.g., Ultra-wideband (UWB), Wi-Fi, Bluetooth, Zigbee, or similar wireless connection). In some embodiments, when the brewer 110 includes the operations controller (e.g., brewer controller 130 of FIG. 1) and the display controller 132, the display controller 132 can be configured to (i) receive information from and/or provide information to the airpot 120, bypassing the main controller, (ii) provide brewing settings to the operations controller, and/or (iii) receive information from and/or provide information to the external network, including sharing information from the airpot 120 for processing external to the brewer system 100. In at least some embodiments, the airpot 120 can also receive and/or provide information to an external network, and still further, can send settings to the brew controller 130 itself.

To facilitate the brewing cycle (e.g., operation of the brewer 110 and/or an iteration of the brewing process), a user can insert the brewing compound into the brew chamber 112 and provide the brewing settings to the brewer 110. Brewing settings can include, for example, a type of brewing compound, an intended beverage, a desired beverage temperature, a desired beverage strength, and/or similar parameters to produce the desired beverage. The user can provide (e.g., input) the brewing settings to the brewer 110 by selecting (i) a brewing recipe from one or more brewing recipes stored within the brewer controller 130 and/or the display controller 132 and including preselected brewing settings, (ii) unique brewing settings, or (iii) an initial brewing recipe, and then modifying the brewing setting thereof. The user can provide the desired brewing settings selection at the brewer display 118 (e.g., via the input devices 119), using a device in communication with the external network, or an interface of the airpot 120. Once the brewing settings are selected, the user can prompt the brewer 110 to start the brewing process. The brewer controller 130, based on the provided brewing settings and the start prompt, can start the brewing process by signaling the water heater 116 or the heated water source to provide a certain volume or volume flowrate of water at a certain temperature to the brew chamber 112.

The brewer controller 130 and/or the display controller 132 can monitor the brewing process by, for example, recording a time period during which the beverage has been brewing or steeping; a temperature of the prepared beverage; a volume of heated water provided to the brew chamber 112; volumes of the prepared beverage (i) collected within the brew chamber 112, (ii) routed to the dispenser 114 and/or the brewer connection port 128, and/or (iii) transferred to the airpot 120; and/or any other suitable brewing metric. The brewer controller 130 can associate these metrics with a specific brewing cycle to generate brewing cycle information which can be stored within the brewer controller 130 and/or the display controller 132, shown on the brewer display 118 during and/or after the brewing process, and/or exported from the brewer 110 to the external network. Brew cycle information can further include information identifying the date of brewing, the time of brewing, a brewer 110 identifier (e.g., identification number), an identifier of the receiving airpot 120, and/or similar identifying information.

FIGS. 2A and 2B are partially schematic views of the airpot 120 configured in accordance with embodiments of the present technology to identify and track characteristics of the brewed beverage. Specifically, FIG. 2A is a side view of the airpot 120 and FIG. 2B is a lower rear perspective view of the airpot 120. As illustrated in FIGS. 2A and 2B, the structure of the airpot 120 can include: (i) a base 121, (ii) a vessel 122 (e.g., a containment vessel or dispenser vessel) supported by the base 121 and configured to contain the beverage, (iii) a cover 123 on the vessel 122, (iv) a handle 124, (v) a spout 125 in fluid communication with the interior of the vessel 122, (vi) the airpot connection port 126 at the base 121, and (vii) an inlet 160. The airpot 120 can also include electronic components for tracking and sharing information regarding the beverage in the vessel 122, as well as for maintaining the fresh beverage for the consumer. For example, the airpot 120 can include: (i) an airpot controller 140, (ii) one or more sensors in communication with the airpot controller 140 for monitoring characteristics of the airpot 120 and the beverage, (iii) a battery 154 supporting the functions of the electrical components, (iv) a heating element 156, and (v) an airpot display 158.

The base 121 can include a housing that is configured to carry one or more of the electronic components of the airpot 120 and that provides an upper surface for supporting the vessel 122. Additionally, an opening in the housing can provide access to the airpot connection port 126, or, alternatively, the airpot connection port 126 can extend from the housing. The opening to the airpot connection port 126 or the protruding airpot connection port 126 can be positioned to align and connect with the brewer connection port 128 when the airpot 120 is carried by the brewer 110.

The vessel 122 can be any suitable container that is coupled to or integrally formed with the base 121 and that provides an interior volume for carrying the beverage. The vessel 122 can include a top having an opening configured to quickly empty the beverage or another liquid from within the vessel 122. When the brewer 110 (FIG. 1) includes the dispenser 114, the opening can further be configured to receive the beverage from the dispenser 114. In some embodiments, the vessel 122 can be a vacuum-insulated glass, plastic, and/or metal container with an interior volume sufficient to carry multiple servings of the beverage (e.g., 32 fl. oz., 64 fl. oz., 96 fl. oz., 128 fl. oz; 1 L, 1.5 L, 2 L, 2.5 L, 3 L).

The cover 123 can be configured to interface with and seal the opening of the vessel 122. In embodiments where the brewer 110 (FIG. 1) includes the dispenser 114, the cover 123 can include a structure for interfacing with the dispenser 114 and providing one-way fluid communication into the vessel 122. The one-way fluid communication can operate such that the beverage received from the dispenser 114 can pass through the cover 123 and into the vessel 122 without removing the cover, but prevents the beverage from escaping the vessel 122 in the event the airpot 120 is partially or fully inverted. In some embodiments, the cover 123 can include a locking mechanism for securing the cover 123 to the vessel 122. Further, the cover 123 and/or the vessel 122 can include a closure sensor 150 configured to detect when the cover 123 seals the opening of the vessel 122 and, when the cover 123 includes a locking mechanism, to detect when the locking mechanism is set to a locked or unlocked position.

The handle 124 can be a structure coupled with the base 121, the vessel 122, or both, and can be configured to allow a user to manipulate the airpot 120. In some embodiments, the airpot 120 can include additional handles 124 for the user to carry or otherwise use or manipulate the airpot 120.

The spout 125 can be a structure coupled to the base 121, the vessel 122, or both, and can be in fluid communication with the interior volume of the vessel 122. The spout 125 can include a handle, button, lever, or any similar suitable mechanism for selectively allowing the beverage to exit the vessel 122 when engaged by the user.

The airpot connection port 126 can be any suitable structure configured to couple with the brewer connection port 128 (FIG. 1) and receive the beverage therefrom. For example, the airpot connection port 126 can include one or more fluid fittings (e.g., male and/or female tubing segments, fittings, or similar receivers) coupled to, or integrally formed with, the airpot 120 or a structure thereof. The one or more fluid fittings can receive the beverage from the brewer connection port 128 and transfer the beverage into the vessel 122 via, for example, the inlet 160. The inlet 160 can include any suitable structure configured to receive the beverage from the airpot connection port 126 and dispense the beverage into the vessel 122. For example, as illustrated in FIG. 2A, the inlet 160 can include a pair of semi-helical, free-standing gooseneck spouts in fluid communication with the airpot connection port 126 and extending from the base 121 toward a top portion of the vessel. Additionally or alternatively, the inlet 160 can include one or more tubes or similar structures extending from the base 121, free standing or connected to an interior surface of the base 121 and/or the vessel 122, and in fluid communication with the airpot connection port 126. In some embodiments, the airpot connection port 126 can include a stop (e.g., a one-way valve) to prevent beverage flow out of the airpot 120. Further, inlet 160 can include a stop to prevent reverse beverage flow from the vessel 122 and/or the inlet 160 to the airpot connection port 126.

The heating element 156 can be any suitable device configured to maintain the beverage within the vessel 122 at a set temperature. For example, the heating element 156 can include one or more of an electric heating coil, heating wire, heating pad, and/or other suitable heating structure within the base 121, between the base 121 and the vessel 122, and/or protruding into or at least partially surrounding the vessel 122.

The airpot controller 140 can be configured to facilitate operation of the airpot 120 and monitor and store information regarding the airpot 120 and the beverage therein, including the occurrence of an inversion and/or dumping event. As used herein, the term “inversion event” refers to an instance in which the airpot 120 is in a position other than an upright position. When the airpot is in this position, the user may be pouring a cup of beverage, or the user may be quickly emptying the beverage in part or in whole, from the airpot 120. The term “dumping event” refers to a subset of inversion events for which the beverage is emptied, in part or in whole, from the airpot 120 and is disposed of. The present technology can be used to detect, and optionally track, one or both of the foregoing events. Tracking dumping events can have particular utility as the results can be used to reduce and/or avoid waste.

The airpot controller 140 can be configured to receive information from, or provide information to, the airpot display 158, the brewer 110 (e.g., to the brewer controller 130 and/or the display controller 132 (FIG. 1)), and/or a network external to the airpot 120 either by a direct connection (e.g., wired, optical, or similar physical connection) or wireless connection (e.g., UWB, Wi-Fi, Bluetooth, Zigbee, or similar wireless connection). The airpot controller 140 can facilitate operation of the airpot 120 by, for example, starting and stopping the heating element 156 to maintain the beverage at a specified temperature. The airpot controller 140 can monitor and store information regarding the airpot 120 and the beverage therein using the one or more sensors in electric communication with the airpot controller 140. Accordingly, the sensor data can be acted upon by the airpot controller 140, and/or the data can be stored at the airpot (e.g., at least temporarily, via an SD card) and then transmitted elsewhere for action. For example, the data can be transmitted to the brewer 110 for action, and/or to another destination, via a wireless and/or other communication link.

The one or more sensors can include: (i) an accelerometer 142, (ii) an optical sensor 144, (iii) a temperature sensor 146, (iv) a contact sensor 148, (v) a closure sensor 150, (vi) a fill-level sensor 152, and/or (vii) any other sensors suitable for tracking information regarding the airpot 120 and/or the beverage. The airpot controller 140 can be configured to periodically and/or continuously receive and/or request information from one or more sensors of the airpot 120 when the beverage is within the vessel 122. Additionally or alternatively, the airpot controller 140 can be configured to receive and/or request information from the one or more sensors (i) when the beverage is initially transferred into the airpot 120, (ii) in response to a user request, (iii) when a reading of one or more sensors reaches a threshold value, and/or (iv) in response to any similar events.

The accelerometer 142 can be any suitable sensor configured to detect both the motion and orientation of the airpot 120. For example, the accelerometer 142 can be a 6-axis IMU and/or a tilt sensor that, in combination with the airpot controller 140, is configured to detect linear and/or rotational motion of the airpot 120, and/or an orientation of the airpot 120, such as upright, upside-down, or any incremental orientation between upright, upside-down, or another orientation.

The optical sensor 144 can be any suitable sensor configured to monitor visual characteristics of the beverage within the vessel 122. For example, the optical sensor 144 can be configured to detect an opacity, turbidity, color, and/or one or more similar characteristics of the beverage.

The temperature sensor 146 can be any suitable sensor configured to collect a temperature reading of the beverage within the vessel 122. For example, the temperature sensor 146 can be a thermocouple partially protruding into the vessel 122 and in thermal contact with the beverage therein.

The contact sensor 148 can be any suitable sensor positioned in or adjacent to the handle 124 to identify when a user grasps the handle 124. For example, the contact sensor 148 can be a capacitive sensor within the handle 124 that senses when the user's hand presses against a surface of the handle. Additionally or alternatively, the contact sensor 148 can be a low-voltage open circuit that is closed when the user grasps the handle 124.

The fill-level sensor 152 can be any suitable sensor for detecting a fill-level of the airpot 120. For example, as illustrated in FIG. 2A, the fill-level sensor 152 can include an element extending into the vessel 122 from the base 121 (e.g., coupled to or independent of the inlet 160), and can be configured to detect a fill-level of the vessel 122. The fill-level sensor 152, in combination with the airpot controller 140, can be configured to detect the fill-level of the vessel 122 as any incremental percentage of the entire interior volume of the vessel 122 (e.g., 10%, 30%, 50%, 70%, 90%), any incremental fluid volume measure (e.g., 5 fl. oz., 10 fl. oz., 15 fl. oz., 20 fl. oz.; 0.10 L, 0.30 L, 0.50 L), or any similar incremental measure of the beverage within the vessel 122. The controller 140 can, from time to time, request and/or store a fill-level reading from the fill-level sensor 152. For example, the controller 140 can periodically (e.g., every 1, 5, 15 seconds) a fill-level reading and store the fill-level reading and earlier fill-level readings (e.g., fill-level readings requested within the preceding 1, 5, 10 minutes).

The airpot 120 can include additional sensors suitable for tracking information regarding the airpot 120 and the beverage therein. Further, the airpot 120 can include one or more (e.g., multiple) of the same sensor positioned in the same, similar, or different locations of the airpot 120 for verifying sensor readings or collecting information from multiple positions of the airpot 120. Information received from the sensors by the airpot controller 140 can be stored at the airpot controller 140 and/or shared with the brewer 110 and/or the external network. When shared, the information can be associated with the airpot 120 identifier (e.g., identification number) and the relevant brew cycle as set by the brewer 110 and additionally stored on the brewer controller 130, the display controller 132, and/or the external network.

Information received from the sensors by the airpot controller 140 can be shown on the airpot display 158 for review and/or alerting the user. For example, the user can view beverage information, such as current temperature, fill-level, age of the beverage (e.g., time elapsed since brewing or delivery to the airpot 120), and/or other similar information on the airpot display 158. Further, the user can set one or more alert conditions regarding the beverage, the brewer 110, and/or the airpot 120 to be shown by the brewer 110, the airpot 120, and/or a device connected to the external network to notify the user when the one or more conditions are met. For example, the user can set an alert using the brewer display 118, the airpot display 158, or the device connected to the external network to notify the user when brewing is complete, when the beverage in the airpot 120 reaches a certain age (e.g., 1 hour has passed since brewing), when the battery 154 in the airpot 120 is low, when the beverage in the airpot 120 falls below a set temperature for an extended time period, and/or any similar alert condition.

In addition to facilitating operation of the airpot 120, and monitoring and storing information regarding the airpot 120 and the beverage therein, the airpot controller 140 can also identify and track airpot 120 inversion events, and in particular embodiments, distinguish between inversion events that qualify as dumping events, and those that do not. The airpot controller 140 can identify (i) when the airpot 120 is likely to experience an inversion event, (ii) whether, following the inversion, the fill-level within the vessel 122 decreased, and (iii) the amount of fill-level decrease. For example, the airpot controller 140 can identify that an inversion event is likely to occur when the airpot 120 is oriented (e.g., rotated) away from an upright position beyond a certain threshold angle. When the accelerometer 142 detects that the airpot 120 is being rotated, if the airpot controller 140 has not recently (e.g., within the minute preceding rotation) recorded the fill-level of the airpot 120, the airpot controller 140 can receive or request a pre-inversion reading from the fill-level sensor 152. Then, if the accelerometer 142 detects that the airpot 120 is rotated beyond a certain threshold angle (e.g., 45°, 90°, 135°, 180°, etc.), the airpot controller 140 can receive or request a post-inversion reading from the fill-level sensor 152.

Additionally or alternatively, the airpot controller 140 can receive or request a post-inversion reading from the fill-level sensor 152 at a predetermined time period after the airpot 120 is returned to the upright orientation. For example, because the remaining beverage in the airpot 120 may slosh after the airpot is returned to its upright orientation, the post-inversion reading from the fill-level sensor 152 can be made 5-10 seconds after the airpot is re-oriented. In other embodiments, the wait time can differ, depending for example on the capacity of the airpot and/or the beverage level or expected beverage level in the airpot. In other embodiments, the airpot controller 140 can average multiple post-inversion fill-level readings, and/or determine when the multiple post-inversion readings have reasonably converged on a stable value, e.g., to be within a target range. In some embodiments, instead of receiving or requesting a fill-level reading before and/or after an inversion event, the airpot controller 140 can retrieve a fill-level reading from the periodic readings stored thereon. In some embodiments, the airpot controller 140 can receive or request a reading from the fill-level sensor 152 any time the contact sensor 148 detects that the user contacted the handle 124.

The threshold angle can be a static value maintained by the airpot controller 140 or can instead be a dynamic value based at least on a current fill-level of the vessel 122. For example, the threshold angle can increase as the fill-level decreases. In some embodiments, if the airpot 120 includes the closure sensor 150 and the airpot controller 140 detects that an inversion event is likely, the airpot controller 140 can receive or request a closure indication from the closure sensor 150 simultaneously or at a similar time as receiving or requesting the pre-inversion reading from fill-level sensor 152. If the closure sensor 150 indicates the cover 123 is secured to the vessel 122, the airpot controller 140 can disregard the inversion event. In some embodiments, following an inversion event, the airpot controller 140 can prompt the airpot display 158 to show a confirmation request asking the user to confirm a dump event has occurred. The user can confirm the dump event via the input devices 119 (shown in FIG. 1) carried by the brewer 110, or via other input devices (e.g., an input device carried by the airpot 120 itself). If the user indicates a dump event did not occur, the airpot controller 140 (or other recipient of the indication) can disregard the inversion event. In further embodiments, the airpot controller 140 can discard the inversion event based on brewing settings input by the user. For example, if the user selected an iced coffee concentrate recipe, the airpot controller 140 can detect the beverage was likely transferred to a different container, as opposed to being disposed of, and disregard the inversion event.

When a dumping event occurs, the airpot controller 140 can compare the pre-inversion and post-inversion fill-level sensor 152 readings to identify a volume of disposed (e.g., dumped) beverage. The airpot controller 140 can share information regarding the dumping event, such as the time of its occurrence, the volume of dumped beverage, and/or similar information, with the brewer controller 130, the display controller 132, and/or the external network, where the information can be associated with the airpot identifier or the brew cycle. Brew cycle information can be reviewed on the brewer 110 and/or another device connected to the external network to identify trends in brew cycles. For example, brew cycle information can be reviewed by the brewer system 100 and/or the user to identify certain times of the day, days of the week, beverages prepared, and/or similar information regarding brewer 110 and airpot 120 activity and performance. Similarly, dumping event information can be reviewed to identify patterns regarding when and what types of beverages are dumped and for which brewers 110 and/or airpots 120 inversion events occur most often.

Identified trends can be used to predict future consumer preferences for a single brewer system 100 or multiple brewer systems. Further, identified trends can be used to predict when beverages are most likely to be dumped and therefore less beverage should be brewed by the brewer system 100. Such information can be provided to the user on the brewer display 118 and/or the airpot display 158, and/or can be provided on the device connected to the external network. This information can allow users to brew beverages in more accurate quantities, identify specific beverages to be brewed when most popular or likely to be purchased by consumers, and/or highlight similar brewing improvements, any/all of which can lead to less disposed beverage and increased sales. Further, this information can allow brewer system operators to spend less time recording amounts of wasted beverage and/or managing waste materials, thus increasing productivity and reducing work-related stress.

As an example, a brew trend can be identified showing that a certain volume (e.g., 1 gal (3.8 L)) of coffee is brewed during a brew cycle by a first brewer at a first location at the same interval (e.g., Wednesdays at 2 PM). The trend can further identify that a certain volume (e.g., 0.5 gal (1.9 L)) of coffee, on average, is dumped during the brew cycle interval (e.g., every Wednesday for the past month). The brewer system 100 can notify (e.g., alert) the user via the brewer display 118, the airpot display 158, and/or the device connected to the external network about the identified brew trend. For example, the airpot display 158 can display a message notifying the user in advance of the analyzed interval (e.g., Wednesdays at 1:45 PM) to brew less coffee to avoid dumping portions thereof. Similar information can be identified and provided to the user including, for example, trends regarding consumed beverages over certain periods of time, as identified by periodic senor readings (e.g., fill-level sensor 152 readings); frequently brewed recipes and/or their required ingredients; volumes of coffee brewed; and/or any similar information regarding brewed beverages and/or the brewer system 100.

### 3.0 Selected Embodiments of the Smart Brewer Networks

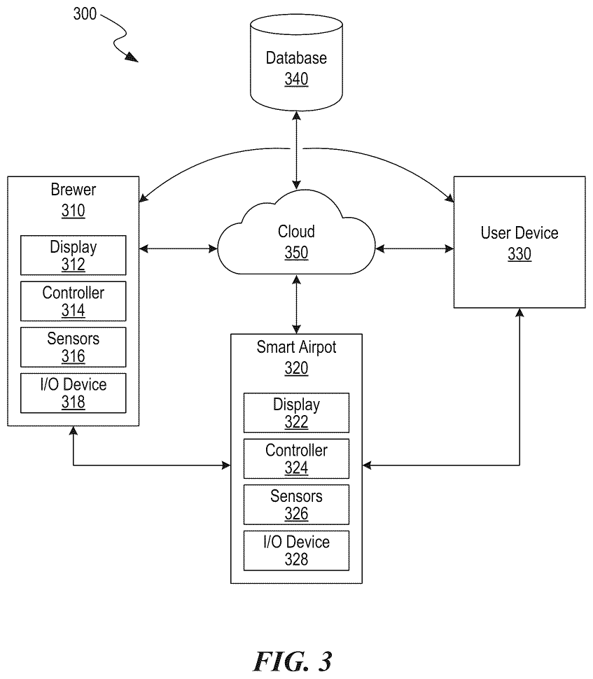

FIG. 3 is a diagram illustrating a smart brewer network 300 configured in accordance with embodiments of the present technology. The network 300 can include one or more smart brewers 310, one or more smart airpots 320, one or more user devices 330, one or more databases 340, and/or other components. One or more of the brewers 310 can include elements and/or functions similar and/or identical to those of the brewer 110 shown in FIG. 1; and one or more of the smart airpots 320 can include elements and/or functions similar and/or identical to those of the airpot 120 shown in FIGS. 2A and 2B. Generally, the network 300 can allow a user to monitor and analyze information generated by a fleet of brewers 310 and airpots 320 positioned at one or more locations. The fleet can be interconnected using a cloud network interface 350. The brewers 310 and the airpots 320 can use this interconnection to store and access generated information from the database 340. The user can use this interconnection for direct access to the generated information at the brewer 310 and/or the airpot 320, and/or from the database 340.

For example, the network 300 can be connected to multiple brewers 310 and/or airpots 320 at multiple beverage store locations. Additionally, from a location the same as or different from at least one beverage store, the user can analyze information collected by the brewers 310 and/or the airpots 320 to review business trends, improve efficiency, predict customer behaviors, and/or generate similar business intelligence. While one or more operations are described as being performed by a particular device or component of the network 300, in some embodiments these operations can be performed by one or more other devices or components of the network 300. For example, if an operation is said to be performed by the airpot 320, all or a portion of the operation can instead be performed by the brewer 310, the user device 330, the database 340, and/or the cloud 350.

As illustrated in FIG. 3, the brewer 310 is a smart brewer for brewing a beverage to refill an airpot, such as the airpot 320 described above, and can include a brewer display 312, a brewer controller 314, sensors 316, an I/O device 318, and/or other components. The brewer controller 314 can be one of two or more controllers, which can include, for example, the airpot controller 324 described below. The brewer 310 can be identified by a unique brewer identifier stored within the brewer controller 314. The brewer display 312 can be configured to show information from the brewer controller 314 regarding the brewer 310, a beverage being prepared at the brewer 310, a beverage prepared and contained by the brewer 310, information from the airpot 320 and/or the network 300, and/or other similar information. Further, the brewer display 312 can be configured to receive inputs from the user, such as selections made using a touchscreen interface. The brewer controller 314 can be configured to provide information to, and receive instructions from, the brewer display 312. The brewer controller 314 can also be configured to receive or request information from one or more sensors 316 collecting information regarding the brewer 310, a beverage being prepared at the brewer, and/or a beverage prepared and contained by the brewer 310. The brewer controller 314 can share collected information or receive instructions using the I/O device 318 and connections established between the I/O device 318 and the airpot 320, the user device 330, and/or the database 340, directly (e.g., by wire or wirelessly) or via the cloud 350. In some embodiments, the brewer 310 can include one or more additional controllers performing some of, the same, or one or more additional operations as the brewer controller 310. For example, an additional controller can be coupled with the display 312 for, among other functions, facilitating communications between the brewer 310 and the airpot, between the brewer 310 and the cloud 350, and for transmitting instructions provided by the user at the display 312 to the brewer controller 314

The airpot 320 is a smart airpot for carrying and dispensing a brewed beverage and can include an airpot display 322, an airpot controller 324, sensors 326, an I/O device 328, and/or other components. The airpot 320 can be identified by a unique airpot identifier stored within the airpot controller 324. The airpot display 322 can be configured to show information from the airpot controller 324 regarding the airpot 320, a beverage contained therein, information from the brewer 310 or the network 300, and/or other similar information. Further, the airpot display 322 can be configured to receive inputs from the user, such as selections made using a touchscreen interface. The airpot controller 324 can be configured to provide information to, and receive instructions from, the airpot display 322. Further, the airpot controller 324 can be configured to receive and/or request information from one or more sensors 326 collecting information regarding the brewer 310 and/or a beverage contained therein. For example, the airpot 320 can include an accelerometer and a fill-level sensor. The accelerometer can detect the motion and orientation of the airpot 320, and the fill-level sensor can detect a volume of the beverage remaining in the airpot 320. The airpot controller 324 can share collected information or receive instructions using the I/O device 328 and a connection established between the I/O device 328 and the brewer 310, the user device 330, or the database 340, directly (e.g., by wire or wirelessly) or via the cloud 350.

The user device 330 can include any type of mobile or stationary device for accessing an online network. For example, the user device 330 can be a desktop computer or laptop, a tablet, a smartphone, a wearable device, and/or other similar user device. The database 340 can be any suitable database for supporting operations and data storage associated with the network 300. The cloud 350 can be (or can include) any wireless communications network and associated hardware and software suitable for supporting data transfer between, and preparing data for use by, the brewer 310, the airpot 320, the user device 330, and/or the database 340.

Information can be stored in the database 340 in connection with brew cycles. For example, when the user uses the brewer 310 to prepare the beverage, the network 300 can, for at least data storage purposes, identify the start of a brew cycle and generate a unique brew cycle identifier associated therewith. Information stored regarding the brew cycle can then be associated with the unique brew cycle identifier. Similarly, information stored regarding the beverage brewed during the brew cycle can be associated with the unique brew cycle identifier. Brew cycles can correspond to a single beverage brewing cycle at a single brewing device, as automatically identified and recorded by the brewer 310, the airpot 320, or by a combination of the brewer 310 and the airpot 320. Additionally or alternatively, the brew cycle can be manually recorded and input by the user on the user device 330.

Information regarding the brew cycle and/or the beverage can include, for example, the brewer 310 identifier, the brew cycle identifier, a location of the brewer 310, brewing settings, a time of brewing, and/or other similar information. If the brewer 310 dispenses the beverage into the airpot 320, the brewer 310 can identify the airpot 320 by a wired or wireless connection between the brewer 310 and the airpot 320 and further associate the airpot identifier with the brew cycle. When the beverage is in the airpot 320, the airpot 320 can continue to provide information for storage in the database and association with the brew cycle, such as periodic temperatures and/or amounts of the beverage within the airpot 320, alerts generated by the airpot 320, inversion events experienced by the airpot 320, and/or similar beverage information.

### 4.0 Selected Methods for Tracking Amounts of Disposed Beverages

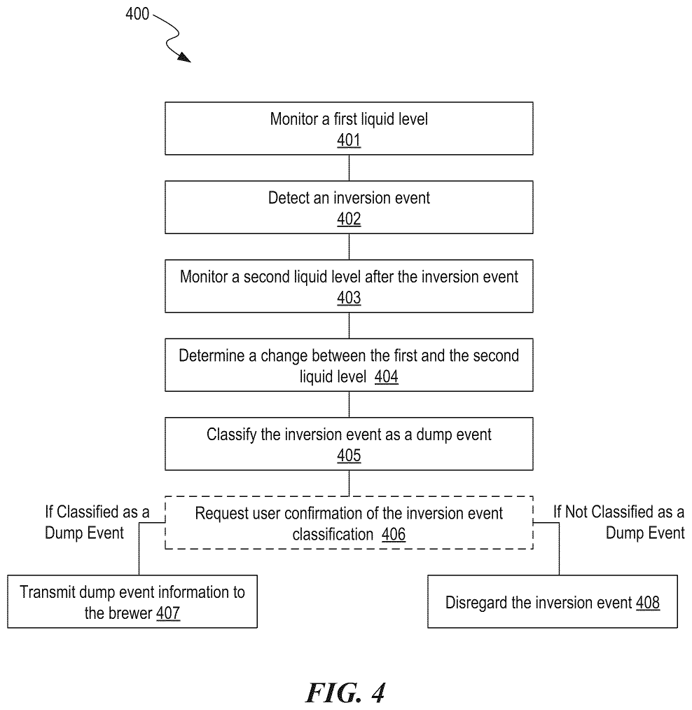

FIG. 4 is a flow diagram illustrating a process 400 for tracking amounts of disposed beverages, in accordance with embodiments of the present technology. The operations included in the process 400 are provided for illustrative purposes and are non-limiting unless otherwise stated. In some embodiments, for example, the process 400 can be accomplished with one or more additional operations not described herein, without one or more operations described herein, or with the operations described in an alternative order. In some embodiments, the process 400 can be implemented via one or more devices (e.g., controllers, computers, etc.) and can include one or more devices executing the process. The process 400 can be used to track amounts of disposed coffee for brewers and airpots with similar configurations to those of (i) the brewer 110 and the airpot 120 of FIGS. 1 and 2, respectively, (ii) the brewer 310 and the airpot 320 of FIG. 3, and/or regarding any smart brewer and smart airpot of a similar smart brewer system. As shown in FIG. 4, the process 400 can include monitoring a first liquid level of a smart airpot (process portion 401); identifying or detecting an inversion event (process portion 402); identifying or detecting a second liquid level after the inversion event (process portion 403) e.g., by monitoring the liquid level; determining a change between the first and the second liquid levels (process portion 404); classifying the inversion event as a dump event or as not a dump event (process portion 405); optionally requesting user confirmation of the inversion event classification (process portion 406); and, if the inversion event is classified as a dump event, transmitting dump event information to a smart brewer (process portion 406), or if the inversion event is not classified as a dump event, disregarding the inversion event (process portion 408).

In process portion 401, the airpot can monitor a first liquid level of a beverage within the airpot. The airpot can monitor the first liquid level using a fill-level sensor or any suitable sensor detecting the amount of beverage within the airpot. The first liquid level can be periodically and/or continuously stored within a controller of the brewer, a controller of the airpot, and/or a network external to the brewer system. In some embodiments, the first liquid level can be stored in response to a condition of the airpot detected by one or more airpot sensors (e.g., when an accelerometer of the airpot detects movement of the airpot).

In process portion 402, the airpot can detect an inversion event. The airpot can detect an inversion event when an accelerometer senses that the airpot is rotated beyond a specified angle, oriented upside-down, or oriented nearly upside-down, with the opening positioned to allow the beverage within the airpot to exit therefrom.

In process portion 403, the airpot can monitor a second liquid level after the inversion event. The airpot can monitor the second liquid level using the fill-level sensor or any suitable sensor detecting the amount of beverage within the airpot. The second liquid level can be received or requested from the fill-level sensor by the controller of the airpot when the accelerometer detects that the airpot is returned to its upright orientation or after a specified amount of time has passed following the inversion event.

In process portion 404, the airpot can determine a change in liquid level between the first and the second liquid levels. The change can be determined by using the controller of the airpot to calculate a difference between the value of the first liquid level and the second liquid level. In some embodiments, the controller of the brewer or a device connected to the external network can calculate the difference between the first and second liquid levels.

In process portion 405, the airpot can classify the inversion event as a dump event, e.g., by using the controller therein to evaluate certain characteristics of the inversion event. Similarly, the controller can use the same or different characteristics to identify the inversion event as not a dump event. The controller can identify the inversion event as a dump event by, for example, evaluating the change in liquid level between the first and second liquid levels. If the change in liquid level is greater than a certain error threshold of the fill-level sensor (e.g., 5%, 10%, 15% of the fill-level sensor reading), or the change in liquid level is great than a certain change in liquid level regardless of error (e.g., greater than 16 fl. oz., 24 fl. oz.; 500 mL, 750 mL), the inversion event can be classified as a dump event.

If the change in liquid level is less than the error threshold or the change in liquid level, the inversion event can be classified as not a dump event. Additionally or alternatively, the inversion event can be classified as not a dump event regardless of change in liquid level. For example, the controller of the airpot can classify the inversion event as not a dump event based on a brewing setting associated with the brew cycle or other sensor readings during the inversion event. For example, if the brewing settings include an iced coffee concentrate or hot water only recipe, the controller can identify the inversion event as, instead, a transfer of the concentrate to another container, or merely the disposal of heated water and therefore not a beverage dump event. Additionally or alternatively, the controller can receive or request information from a closure sensor indicating a cover of the airpot is secured to and seals an opening of the vessel closed. Based on this information, the controller can identify that, although an inversion event has occurred, no beverage from within the vessel was disposed of or dumped.

In process portion 406, the airpot can optionally request the user to confirm that the inversion event was properly classified as or as not a dump event. Following an inversion event and classification thereof as either a dump event or not a dump event, the controller of the airpot can prompt the user at the display of the airpot and/or of the brewer, and/or at a device connected to the external network to select either “yes” or “no,” “confirm” or “deny,” an image of a checkmark or an “X,” a thumbs-up or a thumbs-down, or any similar indication in response to a question confirming proper classification of the inversion event. In some embodiments, the controller can only prompt the user to confirm proper or improper classification of the inversion event by, for example, displaying either “yes” or “no,” or a similar indication, in response to the question confirming proper classification. For example, the display can show “Properly classified as a dump event?” with a “Yes” button on the display of the airpot and, if the user does not select “Yes” within a certain amount of time (e.g., 15, 30, 45 seconds), the controller can modify classification of the inversion event to not a dump event. The process of confirming the inversion event can be carried out at the brewer, at the airpot, or otherwise.

In process portion 407, if the inversion event is classified as a dump event and, optionally, confirmed by the user as such, the airpot can transmit dump event information to the brewer. Additionally or alternatively, the airpot can transmit dump event information to the external network. For example, the airpot controller can transmit information regarding the dump event, including the change in liquid level and the classification of the event, to the brewer and/or the external network. The brewer and/or external network can associate this information with the relevant brew cycle and the additional information associated therewith. The user can review the information regarding the dump event on the airpot display, the brewer display, and/or a device connected to the external network for evaluating inversion events across multiple brewer systems, brewers, and/or airpots.

In some embodiments, the airpot can classify all inversion events as dump events without further analysis and/or processing. In these embodiments, the airpot can monitor the first liquid level (process portion 401), detect the inversion event (process portion 402), monitor the second liquid level after the inversion event (process portion 403), determine the change between the first and the second liquid levels (process portion 404), and classify the inversion event as a dump event (process portion 405) without considering whether the inversion event was not a dump event. The airpot can then transmit the dump event information to the brewer (process portion 407), skipping requesting user confirmation (process portion 406). In these embodiments where the airpot classifies all inversion events as dump events, the dump event information may include a change in liquid level (e.g., from the first liquid level to the second liquid level) of zero.

In process portion 408, if the inversion event is not classified as a dump event at process portion 405 and, optionally, confirmed by the user as such at process portion 406, the airpot can disregard the inversion event and/or remove (e.g., delete) any or all information associated with the event from the airpot controller, the brewer controller, and/or on the external network.

### 5.0 Predictive Brewing, Brewing Recommendations, and Associated Methodologies

The following description provides examples of predictive brewing techniques, and associated methodologies. In a representative embodiment, the system collects a combination of fill, dumping and brew time data. The system (stand-alone or via the cloud) then uses an algorithm to determine improved (e.g., optimal) beverage handling processes. Beverage handling processes, as used herein, can include processes specific to a brew cycle (e.g., brew temperature and time) as well as pre- or post-brew beverage handling techniques. Accordingly, the algorithm can determine improved (e.g., optimal: (a) brew volumes and/or (b) brew times to reduce (e.g. minimize) dumped coffee. It can work as follows: an algorithm minimizes the total amount of dumping by calculating how much is dumped at certain times (e.g. on average 3 L is dumped from 11 am-12 pm on Mondays, so brew 3 L less during this period), or enough beverage is brewed to ensure there is an X % likelihood of meeting demand while also minimizing dumping by brewing more frequently and monitoring fill levels. Different recommendation modes can be based on the manager's goals. The representative system typically would not make recommendations independent of prior dumping data—but instead uses historic brewing data, along with prior dumping data, to make suggestions. The result is that the system recommends how much to brew based on reducing the brew amounts by the historic amount that was dumped—a process that can be based on real time data, and user-set preferences about business goals.

This recommendation can also be guided by user-based recommendations that take into account preferences from the user at the time of setup, such as specifying the length of time the cafe typically holds a pot of brewed coffee. If a cafe holds coffee for only 30 minutes before dumping it, the system can be programmed to brew much smaller volumes to prevent dumping. On the other hand, a cafe that only dumps coffee every two hours can brew a larger volume and deal with more uncertainty over that period by brewing more coffee to cover the interim period. Note that the algorithm can take into account not only historic brew data in determining when to brew, but also real-time data about fill levels and brewing activity the day of the recommendation (e.g. day-of brewing velocity can be a factor, in addition to historic data).

In a particular example, by looking at the collected data, the predictive brewing system determines that to minimize dumped coffee on weekdays, the system should brew a gallon of coffee at open, a gallon of coffee at noon, and ½ a gallon at 3 pm. On weekends, the system can brew a gallon every hour until 2 pm, and then ½ a gallon of coffee every hour until close.

One way of presenting this data to the user is by providing brewing suggestions on the touchscreen. For example, on weekdays, the brewer can indicate that “Our system recommends that you brew a gallon of coffee at noon. Press OK to brew a gallon or CANCEL to not brew.” Another way of presenting the data is through a report. The cafe manager reviews the data to determine the correct recommendations. The system then develops a set of updated recommendations that are prepared and delivered over the cloud to an off-site computer. These recommendations can then be incorporated by the manager into cafe routines by recommending brew times to the staff and changing protocols, rather than having the system make on-the-fly recommendations on the brewer itself.

In a different embodiment, a fully automatic system brews coffee based on the system's determined times, without human input. This embodiment of the system is able to set itself up by adding and removing spent grounds. In still a further embodiment, the system can text the barista's personal phone or flash a message on the shop's point of sale device with a reminder to brew coffee via a cloud-based SMS platform such as Twilio. The system can also text, email or otherwise electronically alert a manager, owner, etc. if recommended brewing times are not being followed within a pre-specified margin. For example, if less than 20% of the recommended coffee is being brewed within a 30 minute period of the recommended brew times, the manager can be electronically alerted.

The smart brewing systems of the present technology, and the associated systems and methods thereof, provide advantages over existing brewing systems by allowing greater control and review of the brewing process, leading to informed system operating decisions by users, reduced beverage waste, and/or more efficient equipment management. For example, information regarding the brewers and/or airpots, the brewing cycles produced thereby, and beverage dump events, can allow users to (i) identify business trends, (ii) predict customer behaviors, and/or (iii) generate similar business intelligence. Further, users can brew more accurate beverage quantities, reducing the amount of disposed beverage, and users can spend less time managing the brewing system (e.g., checking beverage amounts, temperature, age, etc.), increasing productivity and reducing work-related stress.

### 5.0 Conclusion

The above detailed descriptions of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, the brewer system 100 can include only one or more airpots 120 or one or more brewers 110 (e.g., the system 100 can include just airpots 120). Further, one of ordinary skill in the art will understand that various components of the technology can be further divided into subcomponents, or that various components and functions of the technology can be combined and integrated. Although steps are presented in a given order above, alternative embodiments can perform steps in a different order. Furthermore, the various embodiments described herein can also be combined to provide further embodiments. Additionally, in some embodiments, the aspects of the brewing processes and systems described above in the context of an automated or partially automated arrangement can be conducted in a manual arrangement, and vice versa. Although advantages associated with certain embodiments of the technology have been described in the context of those embodiments, other embodiments can also exhibit such advantages, and not all embodiments need necessarily exhibit such advantages to fall within the scope of the technology.

Where the context permits, singular or plural terms can also include the plural or singular term, respectively. As used herein, the term “and/or,” as in “A and/or B” refers to A alone, B alone and both A and B. Additionally, the terms “comprising,” “including,” “having,” and “with” are used throughout to mean including at least the recited feature(s) such that any greater number of the same features or additional types of other features are not precluded. Directional terms, such as “upper,” “top,” “upright,” “upside-down,” and/or similar words can be used herein to express and clarify the relationship between various elements. It should be understood that such terms may not always denote absolute orientation. References herein to “one embodiment,” “an embodiment,” or similar formulations mean that a particular feature, structure, operation, or characteristic described in connection with the embodiment can be included in at least one embodiment of the present technology. Thus, the appearances of such phrases or formulations herein are not necessarily all referring to the same embodiment. As used herein, the terms “about” and “approximately” refer to values within 10% of the stated value. To the extent any materials incorporated herein by reference conflict with the present disclosure, the present disclosure controls.

I/We claim:

1. A beverage dispenser, comprising:
a vessel and a liquid level sensor, wherein the liquid level sensor is positioned to detect a liquid level within the vessel;
a tilt sensor carried by the vessel; and
a controller operably coupled with the liquid level sensor and the tilt sensor, the controller having a computer-readable medium carrying instructions that, when executed, cause the controller to:
receive, from the liquid level sensor, a first signal corresponding to a first liquid level,
determine, in response to a signal from the tilt sensor, the occurrence of an inversion event,
receive, from the liquid level sensor, a second signal corresponding to a second liquid level, and
determine a liquid level change based on the first liquid level and the second liquid level.

2. The dispenser of claim 1, wherein the controller is carried by the vessel.

3. The dispenser of claim 1 wherein the controller is coupled to at least one of the liquid level sensor or the tilt sensor via a wireless link.

4. The dispenser of claim 3 wherein the controller is not carried by the vessel.

5. A brewing system, comprising:
a beverage dispenser including:
a vessel,
a liquid level sensor, wherein the liquid level sensor is positioned to detect a liquid level within the vessel,
a tilt sensor carried by the vessel, and
a first controller operably coupled with the liquid level sensor and the tilt sensor, wherein the first controller is configured to determine a dump event based at least in in part on (i) a signal from the tilt sensor and (ii) a signal change from the liquid level sensor; and
a brewer including a second controller operably coupleable with the first controller to receive dump event information.

6. The brewing system of claim 5, where the first controller is carried by the vessel.

7. The brewing system of claim 5, where the first controller is carried by a user mobile device.

8. The brewing system of claim 5 wherein the first and second controllers are elements of a network, and wherein the network includes instructions that, when executed:
identify multiple dump events from (a) multiple vessels, (b) multiple points in time for a given vessel, or (c) both (a) and (b); and
based on the multiple dump events, identify a change in a beverage handling process for the brewing system.

9. The brewing system of claim 8 wherein the beverage handling process change includes a change in a volume of beverage brewed during a brew cycle.

10. The brewing system of claim 8 wherein the beverage handling process change includes a change in a time of day during which a brew cycle is carried out.

11. A method for managing a beverage via a beverage dispenser, the method including:
monitoring a first dispenser liquid level;
detecting the occurrence of an dispenser inversion event;
monitoring a second dispenser liquid level following the dispenser inversion event;
determining a change between the first dispenser liquid level and the dispenser second liquid level;
classifying the dispenser inversion event as a dump event; and
transmitting dispenser dump event information from the dispenser to a brewer.

12. The method of claim 11, further comprising receiving confirmation from a user that the inversion event is a dump event.

13. The method of claim 11 wherein detecting the occurrence of a dispenser inversion event includes detecting a tilt of the dispenser.

14. The method of claim 11 wherein monitoring the second dispenser liquid level includes delaying monitoring the second dispenser liquid level for a period of time after the dispenser inversion event.

15. The method of claim 11 wherein monitoring the second dispenser liquid level includes identifying when multiple indications of the second dispenser liquid level have converged to be within a target range.

16. The method of claim 11, further comprising collecting information corresponding to multiple events carried out with the dispenser and identifying a beverage handling process change.

17. The method of claim 16 wherein the beverage handling process change includes a change in a volume of beverage brewed during a brew cycle.

18. The method of claim 16 wherein the beverage handling process change includes a change in a time of day during which a brew cycle is carried out.

19. The method of claim 16 wherein the beverage handling process change is carried out automatically, without human input.

20. The method of claim 11 wherein the dispenser is one of a plurality of dispensers, and wherein the plurality of dispensers are coupled via a brewer system network, and wherein the method further comprises collecting information from the plurality of dispensers via the brewer system network.
